(19) United States
(12) Patent Application Publication
(10) Pub. No.: US 2014/0359080 A1
(43) Pub. Date: Dec. 4, 2014

(54) FILE DOWNLOAD METHOD, SYSTEM, AND COMPUTING DEVICE

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: CHUNG-I LEE, New Taipei (TW); DE-YI XIE, Shenzhen (CN); MI-HUA ZHAO, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/288,634

(22) Filed: May 28, 2014

(30) Foreign Application Priority Data
May 30, 2013 (CN) 2013102087838

(51) Int. Cl. H04L 29/08

(52) U.S. Cl. CPC H04L 67/06
USPC 709/219

(57) ABSTRACT

In a file download method executed by a computing device, a download address for each file is generated. The addressed file is stored in a storage system connected to the computing device. In response to a download start request, an addressed file is retrieved from the storage system and transformed into a data stream. Data blocks with a specific length are read from the data stream and transmitted to the client computer. In response to a download suspend request, an offset address is recorded, and transmission of the data blocks is suspended. In response to a download resume request, data blocks of the data stream are read from the offset address and transmission of the data blocks to the client computer is resumed. In response to a download stop request, the transmission of any data block to the client computer is stopped.

### CROSS-REFERENCE TO RELATED APPLICATIONS

This application claims priority to Chinese Patent Application No. 201310208783.8 filed on May 30, 2013 in the China Intellectual Property Office, the contents of which are incorporated by reference herein.

### FIELD

The subject matter herein generally relates to data transmission, and particularly to a method, a system, and a computing device to download files from the computing device to client computers.

### BACKGROUND

In a network situation, files can be stored in a file server, such as a file transfer protocol (FTP) server and client computers can download the files from the file server. How to download the files from the file server conveniently is a problem to be solved.

### BRIEF DESCRIPTION OF THE DRAWINGS

Implementations of the present technology will now be described, by way of example only, with reference to the attached figures.

FIG. 1 is a block diagram of one example embodiment of a hardware environment for executing a file download system.

FIG. 2 is a block diagram of one example embodiment of function modules of the file download system in FIG. 1.

FIG. 3 is a flowchart of one example embodiment of a file download method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

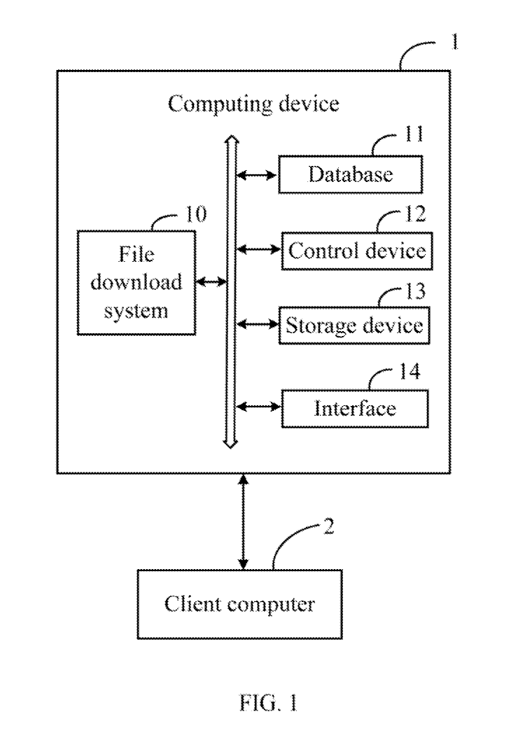

FIG. 1 is a block diagram of one example embodiment of a hardware environment for executing a file download system 10. The file download system 10 is installed and run in a computing device 1 such as a server. The computing device 1 is connected to a plurality of client computers 2 (only one is shown in FIG. 1) via a network. The computing device 1 can include a database 11, a control device 12, a storage device 13, and an interface 14 such as Windows Communication Foundation (WCF) interface.

The database 11 can be installed in the computing device 1 or be externally connected to the computing device 1. The database 11 stores various files that can be downloaded by the client computers 2.

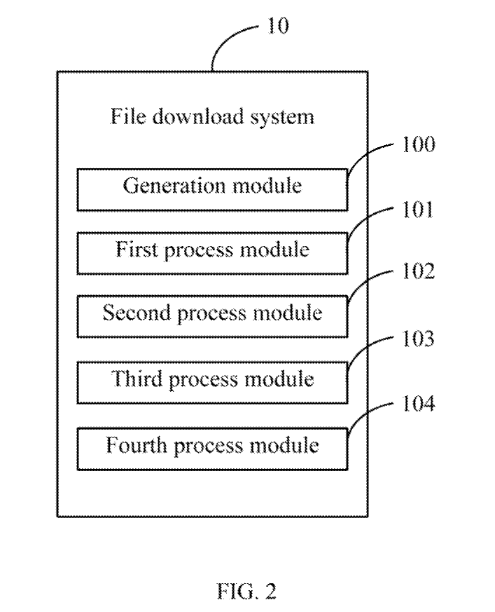

The file download system 10 can include a plurality of function modules (shown in FIG. 2) that facilitate the downloading of files from the computing device 1 to the client computer 2.

The control device 12 can be a processor, an application-specific integrated circuit (ASIC), or a field programmable gate array (FPGA), for example. The control device 12 can execute computerized codes of the function modules of the file download system 10 to realize the functions of the computing device 1.

The storage device 13 can include some type(s) of non-transitory computer-readable storage medium, for example a hard disk drive, a compact disc, a digital video disc, or a tape drive. The storage device 13 stores the computerized codes of the function modules of the file download system 10.

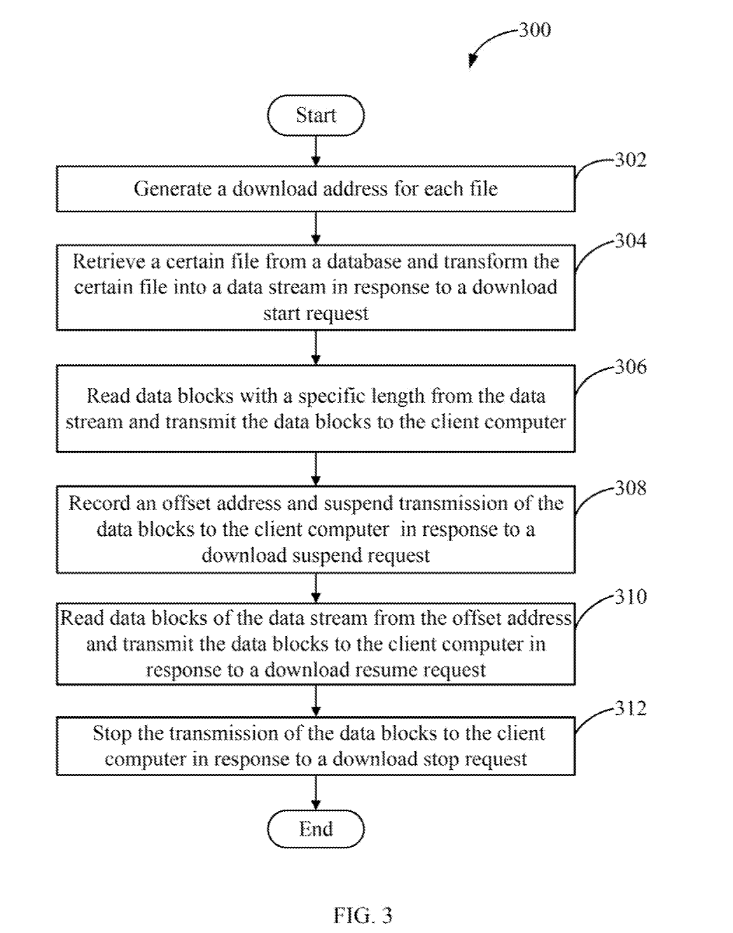

FIG. 2 is a block diagram of one embodiment of function modules of the file download system 10. The function modules can include a generation module 100, a first process module 101, a second process module 102, a third process module 103, and a fourth process module 104. The process modules 100-104 can include computerized codes in the form of one or more programs, which provide at least the functions needed to execute the steps illustrated in FIG. 3.

The generation module 100 generates a download address for each file stored in the database 11 by which each file can be downloaded. The first process module 101, in response to a first request received from the client computer 2, retrieves a certain file from the database 11, transforms the certain file into a data stream, reads data blocks with a specific length one by one from the data stream, and transmits the data blocks to the client computer 2. The second process module 102, in response to a second request received from the client computer 2, records an offset address of a data block that is being transmitted to the client computer 2, and suspends transmission of the data blocks to the client computer 2. The third process module 103, in response to a third request received from the client computer 2, reads data blocks of the data stream from the offset address, and resumes the transmission of the data blocks to the client computer 2. The fourth process module 104, in response to a fourth request received from the client computer 2, stops the transmission of the data blocks to the client computer 2.

FIG. 3 is a flowchart of one example embodiment of a file download method. In the embodiment, the method is performed by execution of computer-readable software program codes or instructions by at least one processor (that is, the control device 12) of the computing device 1.

Referring to FIG. 3, a flowchart is presented in accordance with an example embodiment. The example method 300 is provided by way of example, as there are a variety of ways to carry out the method. The method 300 described below can be carried out using the configurations illustrated in FIGS. 1 and 2, for example, and various elements of these figures are referenced in explaining example method 300. Each block shown in FIG. 3 represents one or more processes, methods, or subroutines, carried out in the example method 300. Furthermore, the illustrated order of blocks is illustrative only and the order of the blocks can be changed. Additional blocks can be added or fewer blocks may be utilized without departing from this disclosure. The example method 300 can begin at block 302.

At block 302, a generation module generates a download address for each file stored in a database or other storage system of a computing device by which each file can be downloaded. According to the download address, each file stored in the database is accessible by a plurality of client computers. In one embodiment, the download address of a file is a uniform resource locator (URL), such as http://xx.xx.xxx.xx/File/a.doc.

In response to a first request from a client computer for starting a download of a certain file stored in the database, at block 304, a first process module retrieves the certain file from the database according to the download address of the certain file, and transforms the certain file into a data stream. In one embodiment, the first process module can determine whether the first request is approved. If the first request is not approved, the flow ends. If the first request is approved, the first process module retrieves the certain file from the database and transforms the certain file into a data stream.

At block 306, the first process module reads data blocks with a specific length (for example, 1024 KB) from the data stream, and transmits the data blocks to the client computer. In one embodiment, the first process module can transmit the data blocks to the client computer via a WCF interface. The first process module can read the data blocks of the data stream one by one. After a data block has been read, the first process module transmits the data block to the client computer. After a data block has been the data block has been transmitted to the client computer, the first process module reads a next data block.

In response to a second request from the client computer for suspending the download of the certain file, at block 308, a second process module records an offset address of a data block that is being transmitted, and suspends transmission of the data blocks to the client computer. In one embodiment, the second process module can determine whether the second request is approved. If the second request is not approved, the flow ends. If the second request is approved, the second process module records the offset address of the current data block that is being transmitted, and suspends the transmission of all data blocks to the client computer.

In response to a third request from the client computer for resuming the download of the certain file, at block 310, a third process module reads data blocks of the data stream from the offset address, and transmits the data blocks to the client computer. In one embodiment, the third process module can determine whether the third request is approved. If the third request is not approved, the flow ends. If the second request is approved, the third process module reads the data blocks of the data stream from the offset address, and resumes the transmission of the data blocks to the client computer.

In response to a fourth request from the client computer for stopping the download of the certain file, at block 312, a fourth process module stops the transmission of data blocks to the client computer. In one embodiment, the fourth process module can determine whether the fourth request is approved. If the fourth request is not approved, the flow ends. If the fourth request is approved, the fourth process module stops the further transmission of any data block to the client computer.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. A file download method, being executed by at least one processor of a computing device, the method comprising:
generating a download address for each file stored in a storage system connected to the computing device;
in response to a first request from a client computer for starting a download of a certain file stored in the storage system, retrieving the certain file from the storage system, transforming the certain file into a data stream, reading data blocks with a specific length from the data stream, and transmitting the data blocks to the client computer;
in response to a second request from the client computer for suspending the download of the certain file, recording an offset address of a data block that is being transmitted to the client computer, and suspending transmission of the data blocks to the client computer;
in response to a third request from the client computer for resuming the download of the certain file, reading data blocks of the data stream from the offset address, and transmitting the data blocks to the client computer; and
in response to a fourth request from the client computer for stopping the download of the certain file, stopping the transmission of data blocks to the client computer.

2. The method according to claim 1, wherein the data blocks are transmitted to the client computer via a Windows Communication Foundation (WCF) interface.

3. The method according to claim 1, wherein the download address is a uniform resource locator (URL).

4. The method according to claim 1, wherein the certain file is retrieved from the storage system upon approval of the first request.

5. The method according to claim 1, wherein the offset address is recorded upon approval of the second request.

6. The method according to claim 1, wherein the data blocks of the data stream are read from the offset address and transmitted to the client computer upon approval of the third request.

7. A computing device, comprising:
a control device; and
a storage device storing one or more programs which when executed by the control device, causes the control device to perform operations comprising:
generating a download address for each file stored in a storage system connected to the computing device;
in response to a first request from a client computer for starting a download of a certain file stored in the storage system, retrieving the certain file from the storage system, transforming the certain file into a data stream, reading data blocks with a specific length from the data stream, and transmitting the data blocks to the client computer;
in response to a second request from the client computer for suspending the download of the certain file, recording an offset address of a data block that is being transmitted to the client computer, and suspending transmission of the data blocks to the client computer;
in response to a third request from the client computer for resuming the download of the certain file, reading data blocks of the data stream from the offset address, and transmitting the data blocks to the client computer; and
in response to a fourth request from the client computer for stopping the download of the certain file, stopping the transmission of data blocks to the client computer.

8. The computing device according to claim 7, wherein the data blocks are transmitted to the client computer via a Windows Communication Foundation (WCF) interface.

9. The computing device according to claim 7, wherein the download address is a uniform resource locator (URL).

10. The computing device according to claim 7, wherein the certain file is retrieves from the storage system upon approval of the first request.

11. The computing device according to claim 7, wherein the offset address is recorded upon approval of the second request.

12. The computing device according to claim 7, wherein the data blocks of the data stream are read from the offset address and transmitted to the client computer upon approval of the third request.

13. A non-transitory storage medium having stored thereon instructions that, when executed by a processor of a computing device, causes the processor to perform a file download method, the method comprising:
generating a download address for each file stored in a storage system connected to the computing device;
in response to a first request from a client computer for starting a download of a certain file stored in the storage system, retrieving the certain file from the storage system, transforming the certain file into a data stream, reading data blocks with a specific length from the data stream, and transmitting the data blocks to the client computer;
in response to a second request from the client computer for suspending the download of the certain file, recording an offset address of a data block that is being transmitted to the client computer, and suspending transmission of the data blocks to the client computer;
in response to a third request from the client computer for resuming the download of the certain file, reading data blocks of the data stream from the offset address, and transmitting the data blocks to the client computer; and
in response to a fourth request from the client computer for stopping the download of the certain file, stopping the transmission of data blocks to the client computer.

14. The non-transitory storage medium according to claim 13, wherein the data blocks are transmitted to the client computer via a Windows Communication Foundation (WCF) interface.

15. The non-transitory storage medium according to claim 13, wherein the download address is a uniform resource locator (URL).

16. The non-transitory storage medium according to claim 13, wherein the certain file is retrieved from the storage system upon approval of the first request.

17. The non-transitory storage medium according to claim 13, wherein the offset address is recorded upon approval of the second request.

18. The non-transitory storage medium according to claim 13, wherein the data blocks of the data stream are read from the offset address and transmitted to the client computer upon approval of the third request.
